(19) United States
(12) Patent Application Publication
(10) Pub. No.: US 2018/0363924 A1
(43) Pub. Date: Dec. 20, 2018

(54) FIBROUS INSULATION MEMBER

(71) Applicant: Owens Corning Intellectual Capital, LLC, Toledo, OH (US)

(72) Inventors: Jason M. Seward, Dresden, OH (US); William Anthony Kunkler, Heath, OH (US)

(21) Appl. No.: 16/007,076

(22) Filed: Jun. 13, 2018

Related U.S. Application Data
(60) Provisional application No. 62/519,190, filed on Jun. 14, 2017.

(51) Int. Cl. F24C 15/34; F16L 59/02; F16L 59/12

(52) U.S. Cl. CPC F24C 15/34; F16L 59/12; F16L 59/026

(57) ABSTRACT

A fibrous insulation member including a layer of fibrous insulation having a first face and a second face that is parallel to and spaced apart from the first face. The fibrous insulation member includes a pre-formed opening defined by curved slits extending through the layer of fibrous insulation from the first face to the second face. The curved slits extend radially outward from a central axis to define curved fingers.

### RELATED APPLICATIONS

This application claims benefit of priority to U.S. Provisional Patent Application No. 62/519,190, filed Jun. 14, 2017, which is incorporated herein by reference in its entirety.

### TECHNICAL FIELD

This invention relates generally to fibrous insulation members, and more specifically relates to fibrous insulation members having a pre-formed opening through the member.

### BACKGROUND

Fibrous insulation is used in a variety of applications to provide thermal and acoustic insulating properties. Fibrous insulation may, for example, be installed as an insulation blanket or batt between framing members on a building structure (e.g., a wall, a roof, or a floor of a building) or within the housing of a thermal appliance, such as for example, ovens and hot water heaters. In some applications, an opening is formed in the blanket to allow an object, such as an electrical component or connection, to project through the blanket. Typically, openings in the blanket are formed either by cutting and removing a portion of the blanket where the object projects through or by forming a cross-shaped cut in the blanket that allows the object to be pushed through. In both approaches, uninsulated areas or voids may exist around the protruding object that can allow heat and/or noise to escape.

### SUMMARY

A fibrous insulation member is disclosed. In one embodiment, the fibrous insulation member includes a layer of fibrous insulation having a first face and a second face that is parallel to and spaced apart from the first face. The fibrous insulation member includes a pre-formed opening defined by a plurality of curved slits extending through the layer of fibrous insulation from the first face to the second face. The plurality of curved slits extend radially outward from a central axis to define a plurality of curved fingers.

In one embodiment, the fibrous insulation member is installed in a thermal appliance. The thermal appliance includes an enclosure, a heating compartment within the enclosure, and a fibrous insulation member disposed between the heating compartment and the enclosure. The fibrous insulation member includes a layer of fibrous insulation having a first face and a second face that is parallel to and spaced apart from the first face. The fibrous insulation member includes a pre-formed opening defined by a plurality of curved slits extending through the layer of fibrous insulation from the first face to the second face. The plurality of curved slits extend radially outward from a central axis to define a plurality of curved fingers.

### BRIEF DESCRIPTION OF THE DRAWINGS

FIG. 1 is a perspective view of an exemplary embodiment of a fibrous insulation member having a pre-formed opening;

FIG. 2 is a perspective view of the fibrous insulation member of FIG. 1 with an object projecting through the opening;

FIG. 3 is a cross-sectional view of the fibrous insulation member of FIG. 2 taken along the plane indicated by lines 3-3 in FIG. 2;

FIG. 4 is a perspective view of an exemplary embodiment of a thermal appliance;

FIG. 5 is a cross-sectional view of the thermal appliance of FIG. 4 taken along the plane indicated by lines 5-5 in FIG. 4;

FIG. 6 is a cross-sectional view of the thermal appliance of FIG. 4 taken along the plane indicated by lines 6-6 in FIG. 4; and

FIG. 7 is a perspective view of an exemplary embodiment of a fibrous insulation member having a pre-formed opening.

### DETAILED DESCRIPTION

The general inventive concepts disclosed herein will now be described by reference to detailed embodiments, in view of the accompanying drawings. These embodiments may, however, be embodied in different forms and should not be construed as limited to the embodiments set forth herein. Rather, these embodiments are provided so that this disclosure will be thorough and complete, and will fully convey the scope of the general inventive concepts to those skilled in the art.

The description and drawings disclose a fibrous insulation member, i.e., an insulation member made, at least in part, from a fibrous material. The term “fibrous material,” as used herein, is defined to mean any material formed from drawing or attenuating molten materials.

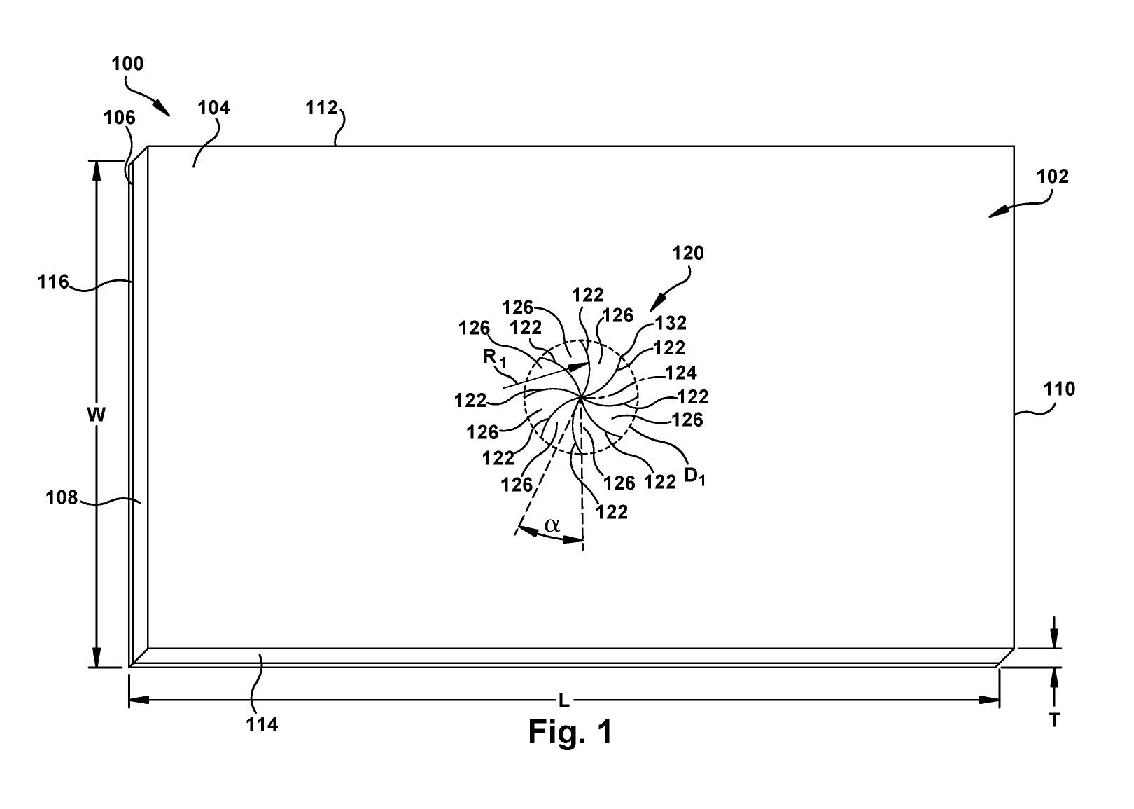

Referring to FIG. 1, an exemplary embodiment of an insulation member 100 is illustrated. The insulation member 100 includes an insulation body 102 made, at least in part, from a fibrous insulating material. The insulation body 102 can be made from a wide variety of different materials and can take a wide variety of different shapes. Examples of suitable insulating materials are disclosed in U.S. patent application Ser. No. 14/465,908, titled Method of Forming a Web from Fibrous Material, filed on Aug. 22, 2014, which is incorporated herein by reference in its entirety. For example, the insulation body 102 may comprise fiberglass insulation, such as a bonded blanket of short glass fibers, a bonded blanket of long glass fibers, or organic and/or inorganic fibers in a thermosetting or thermoplastics resin formed into flexible rolls or batts. In the exemplary embodiment, the insulation body 102 includes a layer of resilient fibrous insulation formed in a generally box-like shape.

The insulation body 102 has a length L, a width W, and a thickness T. The insulation body 102 includes a first face 104 and a second face 106 that is spaced apart from and parallel to, or substantially parallel to, the first face 104. Each of the first face 104 and the second face 106 extend the length L and width W of the insulation body 102. The insulation body 102 includes a first lateral surface 108 and a second lateral surface 110 that is spaced apart from and parallel to, or substantially parallel to, the first lateral surface 108. Each of the first lateral surface 108 and the second lateral surface 110 extend for the width W of the insulation body 102 and extend between the first face 104 and the second face 106. The insulation body 102 includes a first end surface 112 and a second end surface 114 spaced apart from and parallel to, or substantially parallel to, the first end surface 112. The first end surface 112 and the second end surface 114 extend the length L of the insulation body 102 and extend between the first face 104 and the second face 106.

The fibrous insulation body 102 typically has a density within the range from 0.5 lbs/ft³ (8 kg/m³) to 12.0 lbs/ft³ (160 kg/m³), and a thickness within the range from 1.0 inches (2.54 cm) to 3 inches (7.62 cm). In other embodiments, however, the insulation member 100 may have a density greater than 12.0 lbs/ft³ (160 kg/m³) or less than 0.5 lbs/ft³ (8 kg/m³) and a thickness greater than 3 inches (7.62 cm) and less than 1.0 inches (2.54 cm).

In some exemplary embodiments, the insulation member 100 may include a facing 116 that covers one or both of the first face 104 and the second face 106. The facing 116 may serve as an acoustic barrier, a vapor retarder, a radiant heat barrier, or another functional barrier. The facing 116 can take a wide variety of different forms depending on the function it performs. For example, the facing 116 may be a single sheet of material or several layers of material.

The facing 116 can be attached to the insulation body 102 in a wide variety of different ways. For example, the facing 116 can be adhered to the insulation body 102 with an adhesive. A wide variety of different adhesives can be used to adhere the facing to the insulation body 102. For example, the adhesive can be a water-based adhesive, a one-part adhesive, a two-part adhesive, a powder adhesive, a hot melt adhesive, thin film adhesives, a binder, such as a formaldehyde free binder, and a spunbond hot melt adhesive web. The adhesive may be applied in a wide variety of different ways. The adhesive may be applied to the insulation body 102 and/or the facing, for example by spraying, rolling, brushing, etc. When a binder is used, the binder may be a binder that is part of the insulation body 102 and/or the facing 116, and curing of the binder adheres the insulation body 102 to the facing 116.

The facing 116 may be made from a wide variety of different materials. For example, the facing may comprise one or more of nonwoven fiberglass and polymeric media, woven fiberglass and polymeric media, sheathing materials, such as sheathing films made from polymeric materials, scrim, cloth, fabric, foil, tapes, kraft paper or material, and fiberglass reinforced kraft paper (FRK).

The insulation member 100 includes one or more pre-formed openings 120, each configured to receive an object 130 therethrough. In the illustrated embodiment, the insulation member 100 includes a single pre-formed opening 120. In other embodiments, however, the insulation member 100 may include more than one pre-formed opening 120.

The pre-formed opening 120 may be configured in a variety of ways. For example, the location of the opening, the size of the opening, and the shape of the opening may vary in different embodiments. Any opening that allows the object 130 to project through the insulation member 100 while sufficiently conforming to the shape of the object 130 to eliminate or reduce uninsulated areas or voids around the projecting object 130 may be used. In the illustrated embodiment, the pre-formed opening 120 is formed by a plurality of curved slits 122 extending through the insulation body 102 from the first face 104 to the second face 106. The plurality of curved slits 122 extend radially outward from a central axis 124 to define a plurality of curved fingers 126 of the insulation body 102 between the slits 122. In the illustrated embodiment, the pre-formed opening 120 includes eight curved fingers 126. In other embodiments, however, the pre-formed opening 120 can include more or less than eight curved fingers. For example, in some exemplary embodiments the pre-formed opening 120 includes a plurality of curved fingers 126 in the range of six to twelve curved fingers.

In the illustrated embodiment, each of the curved slits 122 extend radially outward from the central axis 124 and end at a distal end 132. In the illustrated embodiment, the distance D1 (illustrated by the dashed line in FIG. 1) from the central axis 124 to the distal ends 132 of each of the curved slits 122 is the same, or substantially the same. In other embodiments, however, the distance D1 from the central axis 124 to the distal end 132 of one of the curved slits 122 may differ from the distance from the central axis 124 to the distal end 132 of another of the curved slits 122. The distance D1 may be selected based on the size of the object 130 that needs to project through the opening 120. For example, in one exemplary embodiment, distance D1 is in the range of 1 inch to 3 inches, such as for example, 2 inches.

In some embodiments, the curvature of the curved slits 122 has a constant radius R1. In other embodiments, however, the curvature of the curved slits may not be a constant radius. In the illustrated embodiments, radius R1 of curved slits 122 is in the range of 1 inch to 5 inches, or 1 inch to 3 inches, or 2 inches. In other embodiments, however, the radius of curvature may be greater than 5 inches or less than 1 inch. In one exemplary embodiment, the ratio of D1:R1 is in the range of 2:1 to 1:2, such as for example 1:1.

The amount of curvature of one of the slits 122 may be expressed as an angle α between a line that extends tangential to the slit 122 adjacent the central axis 124 and a line that extends from the central axis 124 through the distal end 132 of the slit 122. The angle α may vary in different embodiments. In some embodiments, the larger the angle α, the better that the slits 122 conform to the shape of the object 130 projecting through the opening 120 and reduce or eliminate the areas around the projecting object that are void of insulation. In some embodiments, the angle α is 15 degrees or greater, 20 degrees or greater, 30 degrees or greater, 45 degrees or greater, or 55 degrees or greater.

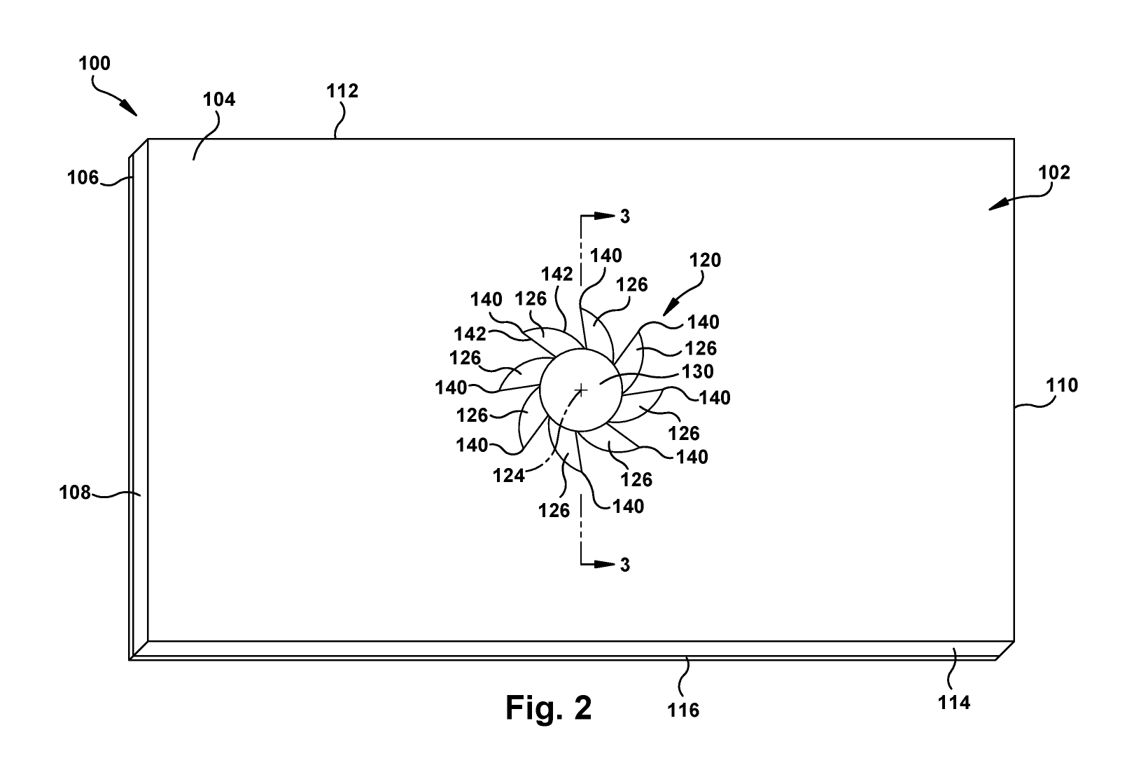

In the illustrated embodiment, the curved fingers 126 include a pointed end 140 and curved lateral side surfaces 142 (see FIG. 2). The slits 122 may be sufficiently thin that, without an object protruding through the opening 120, the lateral side surfaces 142 of each curved finger abuts a lateral side surface 142 of an adjacent curved finger 126. Thus, if an object is not projecting through the opening, the opening is essentially closed. In other embodiments, however, the slits 122 may form a gap (not shown) such that, without an object protruding through the opening 120, the lateral side surfaces 142 of each curved finger do not contact the lateral side surface 142 of an adjacent curved finger 126.

The curved slits 122 may be formed in the insulation member 100 in a variety of ways. Suitable methods of forming the slits 122 include, but are not limited to, cutting the insulation body 102 and facing 116 with a die, waterjet, knife edge or other mechanical cutting tool.

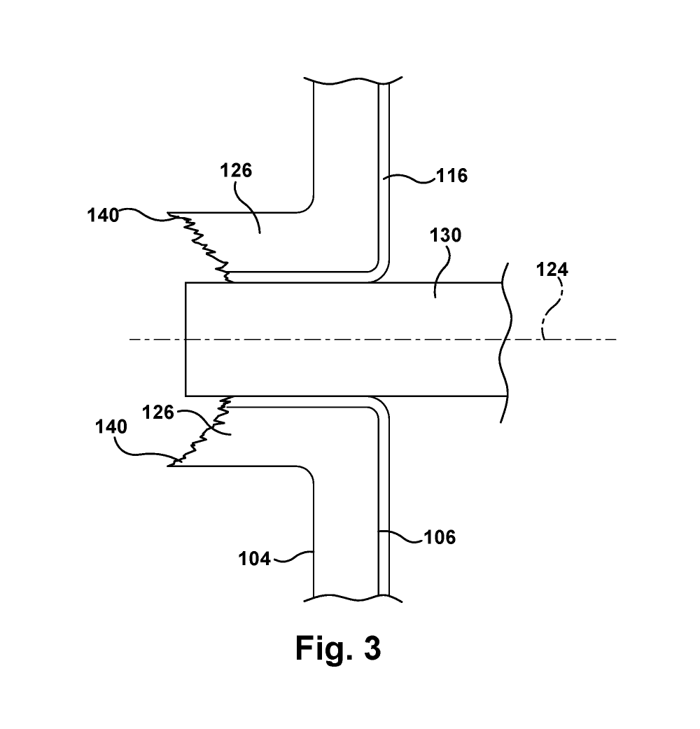

Referring to FIGS. 2 and 3, as indicated above, in some applications, the insulation member 100, when installed, receives the object 130 through the pre-formed opening 120. Thus, the insulation member 100 surrounds the projecting object 130. For example, in some applications, the area in which the insulation member 100 is installed has the object 130 projecting outwards from a surface or other area. The object 130 can be any projecting structure and can be configured in a variety of ways, such as for example, different sizes and shapes. In one exemplary embodiment, the object 130 is an electrical component or connection, such as an electrical outlet or oven light assembly.

As shown in FIGS. 2 and 3, when the object 130 projects through the pre-formed opening 120, the plurality of flexible, curved fingers 126 are bent outward in the direction that the object 130 was inserted through the opening 120. The curvature of the fingers 126, as shown in FIG. 2, result in the fingers 126 conforming to the shape of the object 130 to reduce or eliminate areas around the perimeter of the object 130 that are void of insulation.

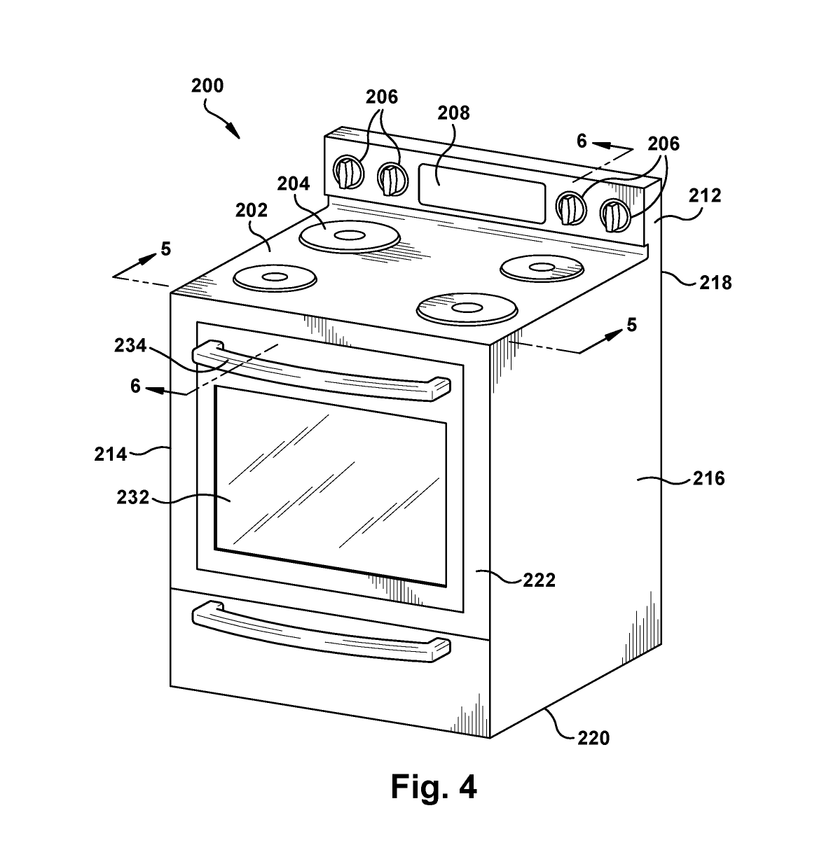

FIG. 4 is a perspective view of an exemplary embodiment of a thermal appliance 200. A thermal appliance is defined as an apparatus or structure for heating an object positioned within the appliance. Various examples of thermal appliances include traditional residential ovens, commercial ovens, microwave ovens, hot water heaters, or any other apparatus or structure sufficient to heat an object positioned within the appliance. In the illustrated embodiment, the thermal appliance 200 is a thermal oven. The concepts of the present application, however, apply to any thermal appliance.

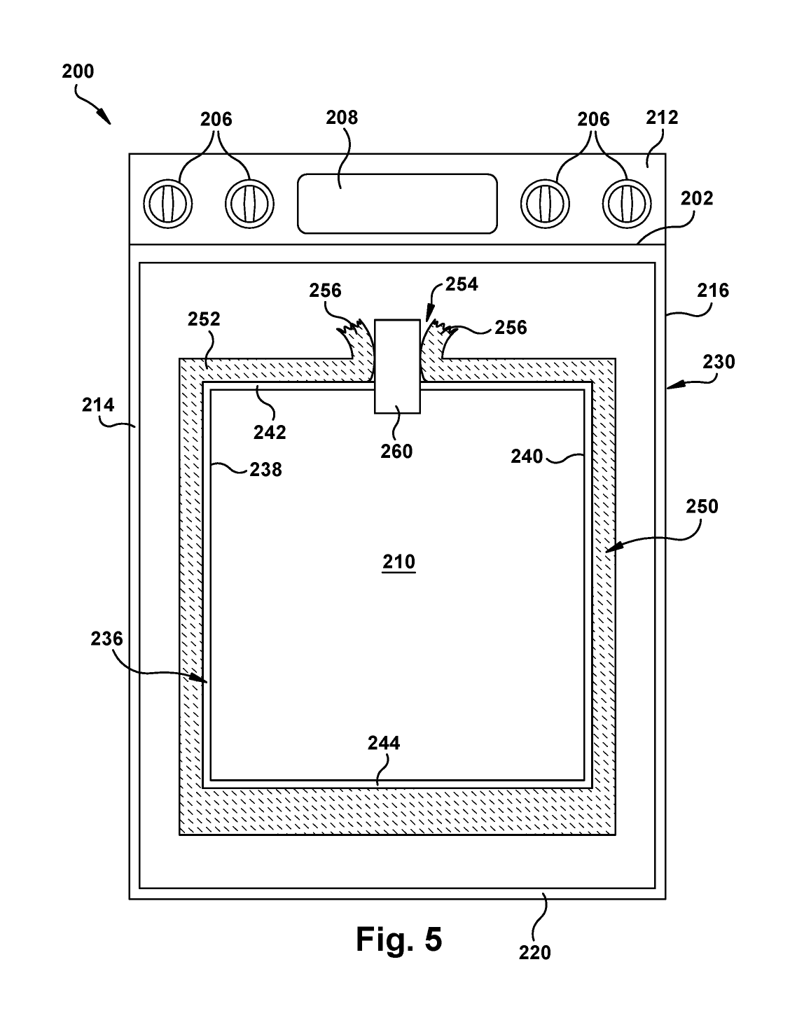

The thermal oven 200 includes a substantially flat, top cooking surface 202. A plurality of heating elements or burners 204 are typically positioned on the top cooking surface 202, although the heating elements or burners 204 are optional. The thermal oven 200 includes a plurality of controls 206 for the burners 204 as well as a control panel 208 for controlling the temperature within a heating compartment 210 (FIG. 5). Typically, the controls 206 and control panel 208 are mounted on a backsplash 212. The backsplash 212 is located on a back edge of the cooking surface 202. The backsplash 212 typically extends away from, and substantially perpendicular to, the cooking surface 202.

The thermal oven 200 includes a pair of opposed side panels 214, 216, a back panel 218, a bottom panel 220, and a front panel 222. The opposed side panels 214, 216, back panel 218, bottom panel 220, front panel 222, and cooking surface 202 are configured to form an enclosure 230. The enclosure 230 is typically finished with an aesthetically pleasing finish, such as for example, a painted finish, a porcelain enamel finish, or a brushed stainless steel finish, particularly for those panels that are exposed to view by consumers.

The front panel 222 includes an insulated oven door 232 pivotally connected to the front panel 222. The oven door 232 is hinged at a lower end to the front panel 222 such that the oven door 232 can be pivoted away from the front panel 222 and the heating compartment 210. The oven door 232 can include a handle 234 configured to facilitate moving the oven door 232 between an open position and a closed position.

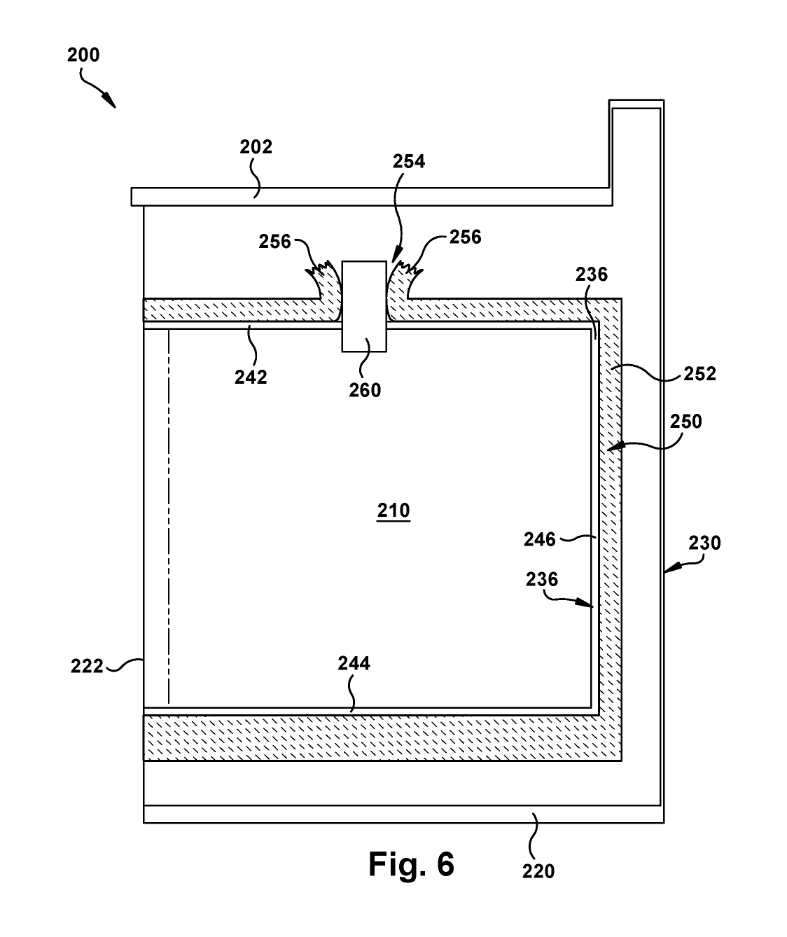

As shown in FIGS. 5 and 6, the enclosure 230 supports an inner oven liner 236. The inner oven liner 236 includes a first liner side 238, an opposing second liner side 240, a liner top 242, a liner bottom 244, and a liner back 246. The opposing liner sides 238, 240, the liner top 242, the liner bottom 244, the liner back 246, and oven door 232 are configured to define the heating compartment 210.

As further shown in FIGS. 5 and 6, the exterior of the oven liner 236 is covered by one or more fibrous insulation members 250. The one or more insulation members 250 may be configured substantially like the fibrous insulation member 100 of FIGS. 1-3 in that the insulation members 250 may include a fibrous insulation body 252 having at least one pre-formed opening 254, as described regarding the fibrous insulation member 100. The one or more insulation members 250 are placed in contact with an outside surface of the oven liner 236.

The thermal oven 200 includes an oven light assembly 260. The oven light assembly 260 projects from the heating compartment 210 outward through the liner 236 and through the pre-formed opening 254 in the insulation member 250. A plurality of curved fingers 256 define the opening 254. The plurality of curved fingers 256 are bent outward by the oven light assembly 260 and, due to the curved shape of the fingers 256, conform to the shape of the portion of the oven light assembly 260 extending through the opening 254. Thus, the size and number of areas around the perimeter of the oven light assembly 260 that are void of insulation are reduced or eliminated.

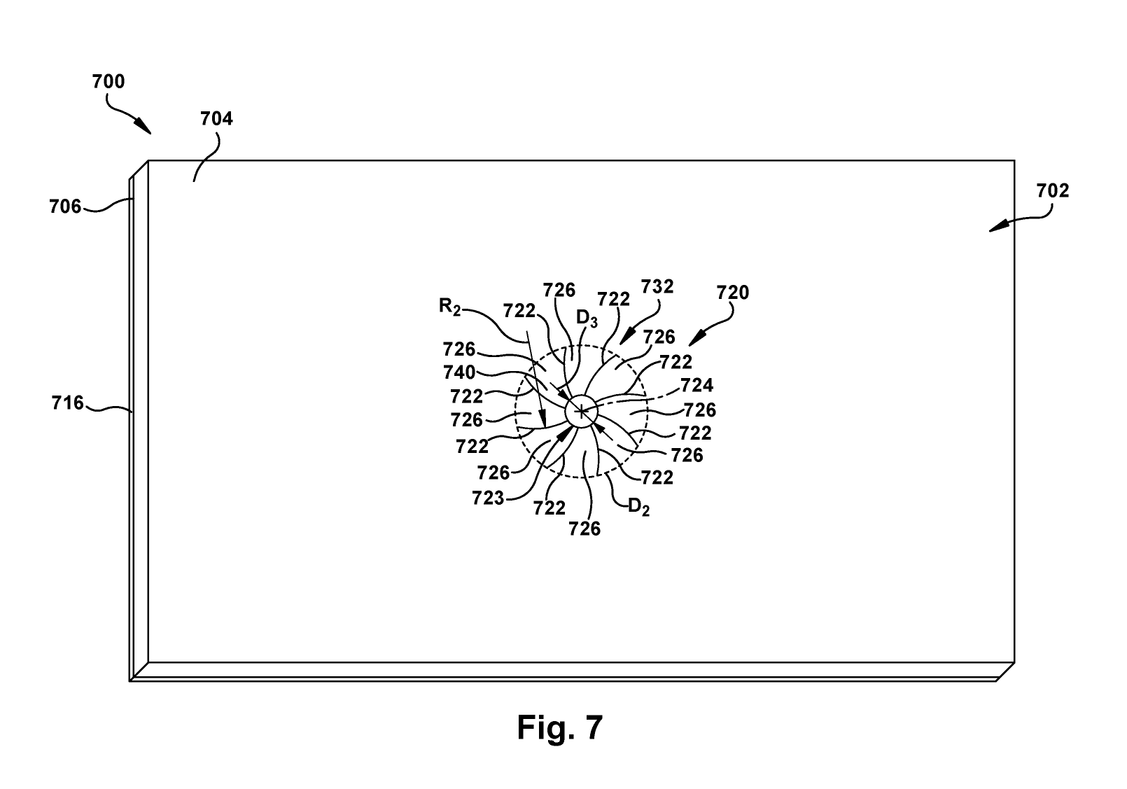

Referring to FIG. 7, an exemplary embodiment of an insulation member 700 is illustrated. The insulation member 700 is substantially like the insulation member 100 of FIGS. 1-3; thus, the description of the insulation member 100 applies equally to the insulation member 700. The insulation member 700, however, includes one or more pre-formed openings 720 that are configured differently than the pre-formed opening 120 of the insulation member 100.

In the illustrated embodiment, the insulation member 700 includes a single pre-formed opening 720. In other embodiments, however, the insulation member 100 may include more than one pre-formed opening 720. The pre-formed opening 720 is configured to receive an object (not shown) therethrough in the same manner as the pre-formed opening 120 of the insulation member 100.

The pre-formed opening 720 may be configured in a variety of ways. For example, the location of the opening, the size of the opening, and the shape of the opening may vary in different embodiments. Any opening that allows an object (not shown) to project through the insulation member 700 while sufficiently conforming to the shape of the object (not shown) to eliminate or reduce uninsulated areas or voids around the projecting object may be used. In the illustrated embodiment, the pre-formed opening 720 is formed by a plurality of curved slits 722 extending through a body 702 of the insulation member 700 from a first face 704 to a second face 706 of the insulation member 700. The plurality of curved slits 722 extend radially outward from a central passage 723 centered on a central axis 724 to define a plurality of curved fingers 726. In the illustrated embodiment, the pre-formed opening 720 includes eight curved fingers 726. In other embodiments, however, the pre-formed opening 720 can include more or less than eight curved fingers. For example, in some exemplary embodiments the pre-formed opening 720 includes at least 3 curved fingers, at least 6 curved fingers, at least 8 curved fingers, at least 12 curved fingers, at least 16 curved fingers, and at least a 24 curved fingers.

In the illustrated embodiment, each of the curved slits 722 extend radially outward from the central passage 723 and end at a distal end 732. In the illustrated embodiment, the distance D1 (illustrated by the dashed line in FIG. 7) from the central axis 724 to the distal ends 732 of each of the curved slits 722 is the same, or substantially the same. In other embodiments, however, the distance D1 from the central axis 724 to the distal end 732 of one of the curved slits 722 may differ from the distance from the central axis 724 to the distal end 732 of another of the curved slits 722.

In some embodiments, the curvature of the curved slits 722 has a constant radius R1. In other embodiments, however, the curvature of the curved slits 722 may not be a constant radius. In the illustrated embodiments, radius R1 of curved slits 722 is in the range of 1 inch to 5 inches, or 1 inch to 3 inches, or 2 inches. In other embodiments, however, the radius of curvature may be greater than 5 inches or less than 1 inch.

In the illustrated embodiment, the curved fingers 726 include a radially-inward, narrow end 740 and curved lateral side surfaces 742 (not shown). The slits 722 may be sufficiently thin that, without an object protruding through the opening 720, the lateral side surfaces (not shown) of each curved finger 726 abut a lateral side surface (not shown) of an adjacent curved finger 726. Thus, if an object is not projecting through the opening 720, the opening is essentially closed. In other embodiments, however, the slits 722 may form a gap (not shown) such that, without an object protruding through the opening 720, the lateral side surfaces (not shown) of each curved finger 726 do not contact the lateral side surface (not shown) of an adjacent curved finger 126.

The central passage 723 may be configured in variety of ways. For example, the size and shape of the passage 723 may vary in different embodiments. In the illustrated embodiment, the central passage 723 is cylindrical with a diameter D3. The ratio A1 of the distance D2 of the distal end 732 of at least one of the curved slits 722 to the diameter D3 of the central passage 723 may be in the range of about 3:1 to about 5:1. The ratio A2 of the radius of curvature R1 to the distance D2 may be in the range of 2:1 to 1:2. In one exemplary embodiment the ratio A1 is 4:1 and the ratio A2 is 1:1.

Like the opening 120 of FIGS. 1-3, when an object projects through the pre-formed opening 720, the plurality of flexible, curved fingers 726 are bent outward in the direction that the object was inserted through the opening 720. The curvature of the fingers 726 result in the fingers 726 conforming to the shape of the object to reduce or eliminate areas around the perimeter of the object 730 that are void of insulation.

The present application discloses different embodiments of a fibrous insulation member having a pre-formed opening the reduces or eliminates uninsulated voids around the perimeter of an object projecting through the opening. Any of the features of any of the embodiments disclosed in this application can be combined with any of the features of any of the other embodiments disclosed by this application. Additional exemplary embodiments of the present application comprise combinations and subcombinations of the features of the exemplary embodiments described above.

What is claimed is:

1. A fibrous insulation member, comprising:
a layer of fibrous insulation having a first face and a second face, wherein the second face is parallel to and spaced apart from the first face; and
a pre-formed opening defined by a plurality of curved slits extending through the layer of fibrous insulation from the first face to the second face, the plurality of curved slits extending radially outward from a central axis that is perpendicular to the first face and the second face, wherein the plurality of curved slits define a plurality of curved fingers.

2. The fibrous insulation member of claim 1, wherein the plurality of curved fingers is six or more fingers.

3. The fibrous insulation member of claim 2, wherein the plurality of curved fingers is eight fingers.

4. The fibrous insulation member of claim 3, wherein each of the plurality of curved slits has a constant radius and a distal end, and wherein the ratio of a distance measured from the central axis to the distal end of at least one of the curved slits and the constant radius of the curved slits is in the range of 2:1 to 1:2.

5. The fibrous insulation member of claim 1, wherein the pre-formed opening further comprises a passage extending along the central axis.

6. The fibrous insulation member of claim 5, wherein the passage is cylindrical.

7. The fibrous insulation member of claim 6, wherein the passage has a radius and each of the plurality of curved slits has a distal end, and wherein the ratio of a distance measured from the central axis to the distal end of at least one of the curved slits and the radius of the passage is in the range of 3:1 to 5:1.

8. The fibrous insulation member of claim 1, wherein the fibrous insulation includes glass fibers.

9. The fibrous insulation member of claim 1, wherein the plurality of slits form an asymmetric pattern.

10. A thermal appliance comprising:
an enclosure;
a heating compartment within the enclosure; and
a fibrous insulation member disposed between the heating compartment and the enclosure,
wherein the fibrous insulation member comprises:
a layer of fibrous insulation having a first face and a second face, wherein the second face is parallel to and spaced apart from the first face; and
a pre-formed opening defined by a plurality of curved slits extending through the layer of fibrous insulation from the first face to the second face, the plurality of curved slits extending radially outward from a central axis to define a plurality of curved fingers.

11. The thermal appliance of claim 10, wherein an object projects from the heating compartment through the pre-formed opening.

12. The thermal appliance of claim 11, wherein the object bends the plurality of curved fingers outward toward the enclosure.

13. The thermal appliance of claim 11, wherein the thermal appliance is a thermal oven and the object is an oven light assembly.

14. The thermal appliance of claim 10, wherein the plurality of curved fingers is six or more fingers.

15. The thermal appliance of claim 10, wherein the plurality of curved fingers is eight fingers.

16. The thermal appliance of claim 10, wherein the pre-formed opening further comprises a passage extending along the central axis.

17. The thermal appliance of claim 16, wherein the passage is cylindrical.

18. The thermal appliance of claim 17, wherein the passage has a radius and each of the plurality of curved slits has a distal end, and wherein the ratio of a distance measured from the central axis to the distal end points of at least one of the curved slits and the radius of the passage is in the range of 3:1 to 5:1.

19. The thermal appliance of claim 10, wherein the fibrous insulation member includes glass fibers.
